(19) United States
(12) Patent Application Publication
(10) Pub. No.: US 2008/0289373 A1
(43) Pub. Date: Nov. 27, 2008

(54) Automotive Door Lock Device

(75) Inventors: Makoto Suzumura, Aichi-ken (JP); Akira Muramatsu, Aichi-ken (JP); Kazuhisa Hidaka, Aichi-ken (JP); Kazutaka Kojima, Aichi-ken (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/667,731

(22) PCT Filed: Nov. 16, 2005
(86) PCT No.: PCT/JP05/21399

§ 371 Date: May 15, 2007

(30) Foreign Application Priority Data
Nov. 17, 2004 (JP) 2004-332631
Nov. 17, 2004 (JP) 2004-332632

(51) Int. Cl. E05B 65/20

(52) U.S. Cl. 70/91

(57) ABSTRACT

This invention provides an automotive door lock device capable of securely preventing a dropout of an operation connecting portion of operation means from an operating lever connecting portion of an operating lever member. In an automotive door lock device comprising a housing 10 having a housing body including an opening portion 13, and a cover portion 122b formed integrally with the housing body 12 for opening and closing the opening portion 13; an operating lever member 21 placed in the housing 10 and having an operating lever connecting portion 21c; and operation means 52 having an operation connecting portion 52a to be connected to the operating lever connecting portion 21c, the automotive door lock device of the present invention is characterized in that the cover portion 122b of the housing has a projecting portion 122c for preventing a dropout of the operation connecting portion 52a of the operation means 52.

### TECHNICAL FIELD

The present invention relates to an automotive door lock device.

### BACKGROUND ART

The device recited in Patent Document 1 is known as a conventional automotive door lock device. The automotive door lock device is provided with a resinous housing, and an opening is formed on the housing. An operating lever connecting portion of an operating lever is exposed through the opening of the housing, and the operating lever connecting portion is connected to an operation connecting portion provided on a locking cable which serves as an operation means. Here, a cover portion for opening and closing the opening of the housing is integrally formed with the housing.

In this type of automotive door lock device, the cover portion is precisely engaged with the opening of the housing and water penetration can be prevented. Moreover, since the cover portion is integrally formed with the housing, the number of component parts can be reduced, and so the device provides a construction which enables low-cost production.

### (Patent Document 1: Japanese Unexamined Patent Publication (Kokai) No. 2002-129813)

### DISCLOSURE OF THE INVENTION

### Problems to be Solved by the Invention

However, it is difficult to say that the abovementioned automotive door lock device has a structure capable of preventing a dropout of the connecting portion of the operation means from the connecting member of the operating lever.

The present invention has been conceived in view of the abovementioned conventional circumstances, and it is an object of the present invention to provide an automotive door lock device capable of securely preventing a dropout of the connecting portion of the operation means from the connecting member of the operating lever. Furthermore, it is another object of the present invention, which has been found in view of the abovementioned conventional circumstances, to provide an automotive door lock device capable of easily connecting the connecting portion of the operation means with the connecting member of the operating lever.

### Means for Solving the Problems

Technical means taken in the present invention for solving the above problems is characterized in that, in an automotive door lock device in which an operation connecting portion of operation means is to be connected to an operating lever connecting portion of an operating lever member placed in a resinous housing through an opening formed on the housing, a cover portion capable of opening and closing the opening of the housing is integrally formed with the housing, and an arc-shaped projecting portion for preventing a dropout of the operation connecting portion of the operation means is formed on the cover portion, and the projecting portion is located along an arc-shaped moving locus of the operation connecting portion. Namely, in an automotive door lock device comprising: a housing having a housing body including an opening portion, and a cover portion formed integrally with the housing body for opening and closing the opening portion; an operating lever member placed in the housing and having an operating lever connecting portion; and operation means having an operation connecting portion to be connected to the operating lever connecting portion,

The automotive door lock device of the present invention is characterized in that the cover portion of the housing has am arc-shaped projecting portion for preventing a dropout of the operation connecting portion of the operation means, and the projecting portion is located along an arc-shaped moving locus of the operation connecting portion. In the automotive door lock device of the present invention, the operation connecting portion of the operation means connected to the operating lever connecting portion of the operating lever is inhibited from dropping off from the operating lever connecting portion by the projecting portion provided on the cover of the housing. Therefore, the dropout of the operating lever connecting portion and the operation connecting portion is inhibited, and the function of the door lock device is maintained properly.

It is preferable that this projecting portion prevents the dropout by inhibiting movement in a direction to separate from the operating lever connecting portion to which the operation connecting portion is connected.

Moreover, it is preferable that a convex portion capable of contacting the operating lever member is formed on the housing body, which constitutes a main part of the housing, at a position facing the projecting portion of the cover portion in a closed state. This convex portion can prevent the dropout by inhibiting movement in a direction to separate from the operation connecting portion to which the operating lever connecting portion is connected.

The operating lever member and the operation means which are connected to each other are located in a space formed between the housing body and the cover member, and furthermore the operating lever member and the operation means are to be located between the convex portion of the housing body and the projecting portion of the cover member. When the operating lever member and the operation means respectively move in directions to drop out, the operating lever member and the operation means bump against the convex portion of the housing body or the projecting portion of the cover member, so that their movements are inhibited and the dropout is inhibited. It is to be noted that the projecting portion and the convex portion contact the operating lever member and the operation means at their fore ends, so that the contact area is small. Therefore, even in contact with the projecting portion and the convex portion, the operating lever member and the operation means show little resistance to the contact, and the contact does not hinder smooth movements of the operating lever member and the operation means.

Either one of the operating lever connecting portion and the operation connecting portion can be constituted by a concave portion, and the other one of the operating lever connecting portion and the operation connecting portion can be a spherical portion to be attached and connected to the concave portion. It is preferable that the operating lever connecting portion is the concave portion and that the operation connecting portion is the spherical portion held slidably by this concave portion. Owing to a combination of the concave portion and the spherical portion to be attached to it, attachment becomes easy and the concave portion and the spherical portion can be rotated with respect to each other, thereby increasing the degree of relative movement freedom.

It is also preferable that a tapered surface is formed on an opening periphery of the concave portion so as to have an enlarged opening end shape. This makes the attachment of the spherical portion to the concave portion much easier. It is also preferable that a projection is formed inside the opening periphery of the concave portion. This projection inhibits the dropout of the attached spherical portion from the concave portion. It is possible to form a plurality of projections.

Moreover, an opening of the concave portion can face the opening portion of the housing body. An operation to attach the spherical portion into the concave portion through the opening of the opening portion becomes easy. It is to be noted that it is preferable that space sectioned by the concave portion is hemispherical. This makes the attachment easy and makes the relative rotation with respect to the spherical portion smooth.

Furthermore, it is preferable that the projecting portion is an arc-shaped convex ridge located along a moving locus of the operation connecting portion. It is preferable that the convex portion is also an arc-shaped convex ridge located along a moving locus of the operating lever member. Even if the operation connecting portion and the operating lever connecting portion are moved by an operation and their locations within the housing are changed, owing to these convex ridges the operation connecting portion and the operating lever connecting portion are always located between the projecting portion and the convex portion, and the lock device has a function of preventing separation of the operation connecting portion and the operating lever connecting portion by the projecting portion and the convex portion.

It is preferable that the housing body and the cover portion have distance keeping means for keeping the distance between the housing body and the cover portion constant when the cover portion is in a closed state. Owing to this distance keeping means, the relative positions of the housing body and the cover portion are kept constant more securely when the cover portion is in the closed state, and even if some large force for separation is applied on the operation connecting portion and the operating lever connecting portion and as a result a large force is applied to relatively separate the housing body and the cover portion by way of the projecting portion and the convex portion, the distance keeping means inhibits relative separating movements and accordingly inhibits the separation between the operation connecting portion and the operating lever connecting portion.

### ADVANTAGES OF THE INVENTION

According to the present invention, after the operating lever connecting portion of the operating lever member and the operation connecting portion of the operation means are connected to each other, the opening of the housing can be closed by the cover portion formed integrally with the housing body. At this time, the projecting portion is formed on the cover portion, and the projecting portion prevents a dropout of the operation connecting portion of the operation means. Therefore, if the operation connecting portion of the operation means is connected to the operating lever connecting portion of the operating lever member placed in the housing and the cover portion closes the opening, the operation connecting portion of the operation means becomes difficult to drop off from the operating lever connecting portion of the operating lever member. Therefore, the connection between the operation connecting portion of the operation means and the operating lever connecting portion of the operating lever member can be secured only by closing the housing with the cover portion.

Therefore, in the automotive door lock device of the present invention, a dropout of the operation connecting portion of the operation means from the operating lever connecting portion of the operating lever member can be securely prevented.

Moreover, according to the present invention, since the convex portion is formed at the position facing the projecting portion of the cover portion in a closed state, the convex portion is located in the housing so as to face the projecting portion of the cover portion. Therefore, owing to the contact of the convex portion with the operating lever member, the convex portion and the projecting portion of the cover portion can sandwich the connection between the operating lever connecting portion of the operating lever member and the operation connecting portion of the operation means. Therefore, the dropout of the operation connecting portion of the operation means from the operating lever connecting portion of the operating lever member can be more securely prevented.

Moreover, according to the present invention, the operating lever connecting portion of the operating lever member has a concave shape and the operation connecting portion of the operation means has a spherical shape. Therefore, the operation connecting portion can be easily connected to the operating lever connecting portion. Moreover, since the operating lever connecting portion comes in slidable contact with the operation connecting portion, even when the operating lever connecting portion and the operation connecting portion move along an arc-shaped moving locus, their connection is hardly broken.

Therefore, in the automotive door lock device of the present invention, the operation connecting portion of the operation means can be easily connected to the operating lever connecting portion of the operating lever member.

Moreover, according to the present invention, since the tapered surface is formed on the opening periphery of the concave portion, the operation connecting portion can be easily connected to the operating lever connecting portion. Moreover, since a pair of projections is formed inside the opening periphery of the concave portion, if the operation connecting portion is connected to the operating lever connecting portion, the operation connecting portion can be difficult to drop off from the operating lever connecting portion.

### BRIEF DESCRIPTION OF THE DRAWINGS

FIG. 1 is a perspective exploded view of an automotive door lock device according to an embodiment.

FIG. 2 is a perspective view of the entire automotive door lock device according to the embodiment.

FIG. 3 is a plan view illustrating a latch mechanism of the automotive door lock device according to the embodiment.

FIG. 4 is a partial front elevational view of the automotive door lock device according to the embodiment in an initial unlocked state.

FIG. 5 is a partially enlarged view of the automotive door lock device according to the embodiment.

FIG. 6 is a partially enlarged sectional view of the automotive door lock device according to the embodiment.

FIG. 7 is a partial front elevational view of the automotive door lock device according to the embodiment in an unlocked and unlatched state.

FIG. 8 is a partial front elevational view of the automotive door lock device according to the embodiment in an initial locked state.

FIG. 9 is a partial front elevational view of the automotive door lock device according to the embodiment in a locked state.

### BEST MODE FOR CARRYING OUT THE INVENTION

Hereinafter, best mode for carrying out the present invention will be described based on the drawings with reference to an embodiment.

### Embodiment

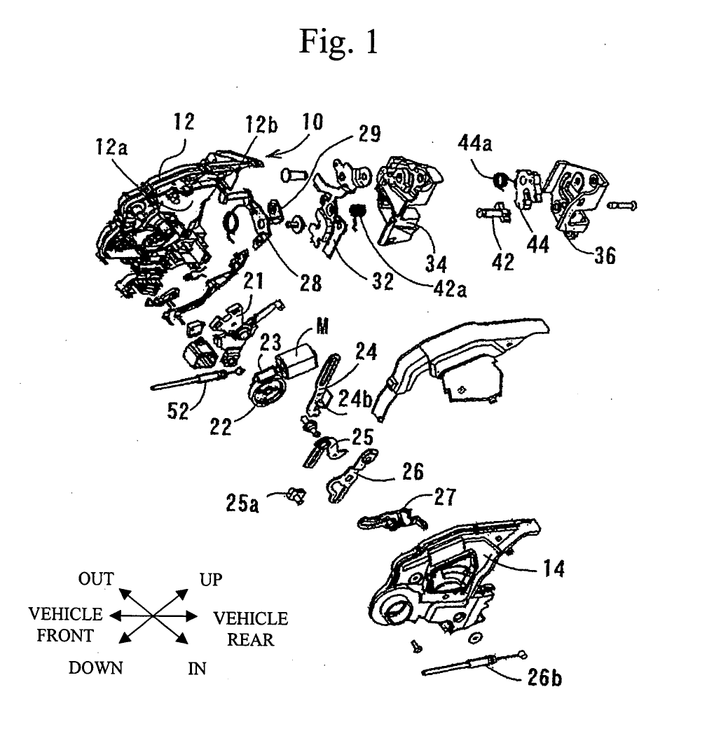

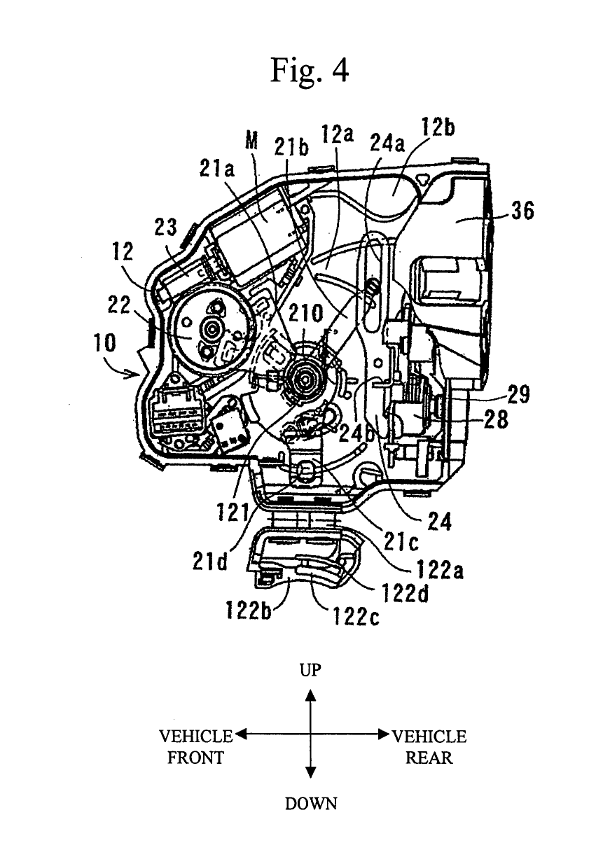

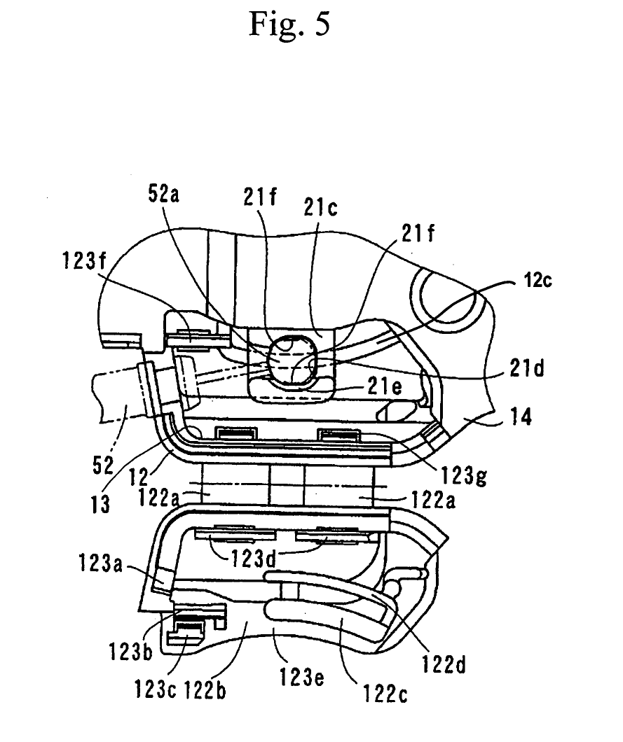

An embodiment of automotive door lock device is provided, as shown in FIGS. 1 and 5, with a main casing 12 and a first cover 14, as a resinous housing 10. As shown in FIG. 4, the main casing 12 includes a dish-shaped first casing portion 12a which opens inward, and a dish-shaped second casing portion 12b which adjoins the first casing portion 12a and opens inward. Moreover, as shown in FIG. 5, the inside of the main casing 12 is covered with the first cover 14.

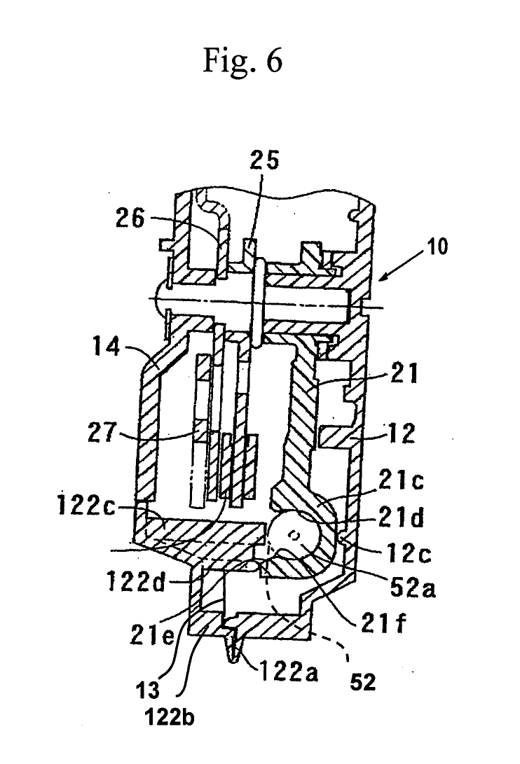

Between the main casing 12 and the first cover 14, the door lock device is provided, as shown in FIG. 6, with a locking lever 21, a second inside lever 25, a first inside lever 26, a child protector 27, and as shown in FIG. 4, with a wheel gear 22, a motor M provided with a worm gear 23, an open link 24, an open lever 28 and a lift lever 29. It is to be noted that the locking lever 21 constitutes the operating lever member of the present invention.

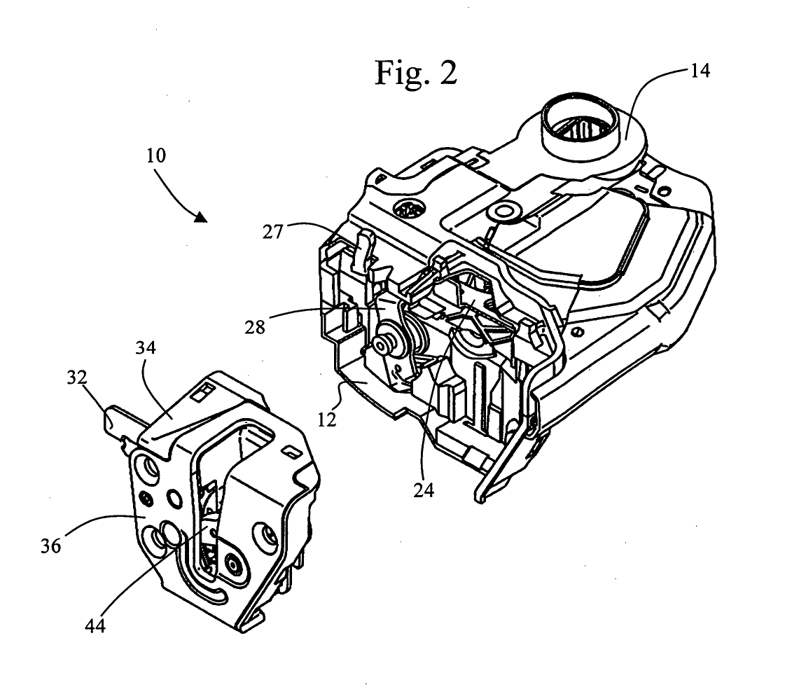

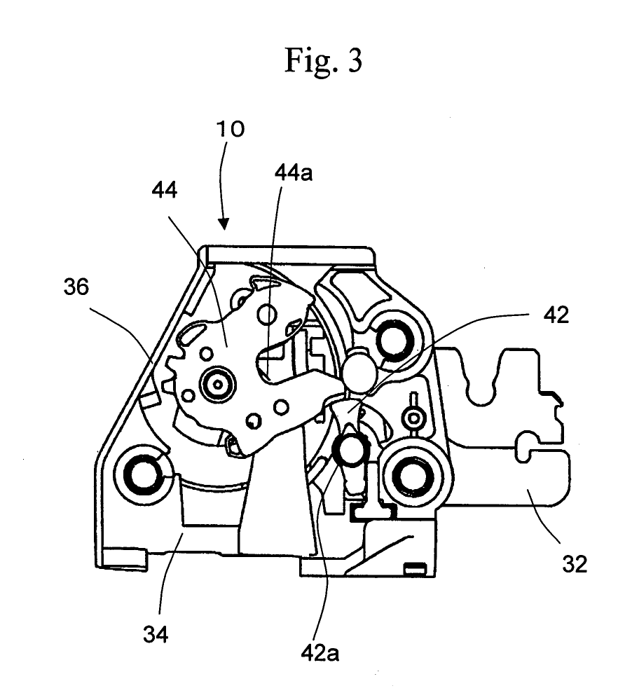

FIG. 2 illustrates a perspective view of the entire automotive door lock device. A rear end of the housing 10 is opened by a rear end of the main casing 12 and a rear end of the first cover 14, and covered by a plate-shaped metallic sub base plate 32. Moreover, as shown in FIG. 3, this sub base plate 32 is covered by a dish-shaped resinous body base plate 34 which opens forward. A pawl spring 42a is placed between the sub base plate 32 and the body base plate 34, and the pawl spring 42a urges one end of a pawl 42 which penetrates the body base plate 34 from the rear side to the front side. The body base plate 34 is covered by a dish-shaped metallic base plate 36 which opens forward. Between the body base plate 34 and the base plate 36 there are placed the pawl 42, a ratchet 44, and a ratchet spring 44a which urges the ratchet 44. It is to be noted that the pawl 42 and the ratchet 44 are urged to engage each other.

FIG. 4 shows a state in which the opening of the housing 10 is open and, when this door lock device is mounted on an automobile, the left side is to be the front side of the automotive door lock device and the right side is to be the rear side of it.

As shown in FIG. 4, a swing shaft center 121 protrudes around a center of the main casing 12 of the housing 10, and the swing shaft center 121 is swing-ably engaged with a swing center 210 of the locking lever 21. The locking lever 21 is an integral body of a fan-shaped active lever 21a and a bar-shaped sub lever 21b. The locking lever 21 is provided with an operating lever connecting portion 21c which extends downward. A concave portion 21d which forms a roughly hemispherical space is formed on the operating lever connecting portion 21c. It is to be noted that the operating lever connecting portion 21c constitutes the operating lever connecting portion of the present invention and that the locking lever 21 having the operating lever connecting portion 21c constitutes the operating lever member of the present invention. It is also to be noted that the concave portion 21d constitutes the concave portion defined in the present invention.

Moreover, as shown in FIG. 5, an operation connecting portion 52a located at a fore end of a locking cable 52, which constitutes the operation means of the present invention, is engaged with the concave portion 21d of the operating lever connecting portion 21c. The operation connecting portion 52a is spherical and in slidable contact with the concave portion 21d inside the concave portion 21d. Here, a tapered surface 21e is formed on an opening periphery of this concave portion 21d, and a pair of projections 21f is formed inside that opening periphery. It is to be noted that this operation connecting portion 52a constitutes the operation connecting portion of the present invention which serves as the spherical portion. It is also to be noted that the projections 21f constitute the projections of the present invention. Thus, the operation connecting portion 52a is internally held by the concave portion 21d which has the tapered surface 21e and the projections 21f on the opening periphery. In this way, the tapered surface 21e makes it easy to connect the operation connecting portion 52a to the concave portion 21d. Moreover, if the operation connecting portion 52a is connected to the concave portion 21d, the projections 21f make it difficult for the operation connecting portion 52a to drop off from the concave portion 21d. Therefore, a dropout of the operation connecting portion 52a from the concave portion 21d can be securely prevented.

As shown in FIG. 5, an opening portion 13 is formed on the underside of the main casing 12, which is covered by the first cover 14. A pair of thin connecting pieces 122a is integrally formed at a lower end of the main casing 12, and a cover body 122b is integrally formed with those connecting pieces 122a. The connecting pieces 122a and the cover body 122b constitute a cover portion integrally formed with the housing 10. It is to be noted that the first cover 14 constitutes the housing body of the present invention and that the cover body 122b constitutes the cover portion of the present invention. A retaining projection 123a, a stopper projection 123b, an elastic retaining hook 123c, a pair of elastic retaining pieces 123d, a flange 123e and a drain notch are formed on the cover body 122b. The retaining projection 123a, the stopper projection 123b and the elastic retaining hook 123c constitute the distance keeping means of the present invention. A projecting portion 122c having a downwardly convex arc shape and projecting perpendicularly to the plane of FIG. 5 is formed on the cover body 122b. Moreover, an auxiliary projecting portion 122d which reinforces the projecting portion 122c is formed along the shape of the projecting portion 122c. This cover body 122b is folded by the connecting pieces 122a after the operation connecting portion 52a is engaged with the abovementioned concave portion 21d, and the opening portion 13 is closed by the cover body 122b. It is to be noted that the projecting portion 122c constitutes a protruding ridge which serves as the projecting portion of the present invention.

Here, as shown in FIG. 6, the projecting portion 122c of the cover body 122b is located in front of the operation connecting portion 52a connected to the concave portion 21d, and the auxiliary projecting portion 122d protrudes from the projecting portion 122c at a position facing the concave portion 21d. Moreover, a convex portion 12c which can contact the locking lever 21 is formed inside the main casing 12 at a position facing the projecting portion 122c of the cover body 122b. It is to be noted that this convex portion 12c constitutes a protruding ridge which serves as the convex portion of the present invention.

Moreover, as shown in FIG. 5, the projecting portion 122c and the auxiliary projecting portion 122d have an upwardly convex arc shape, and in a state in which the opening portion 13 is closed by the cover body 122b, the projecting portion 122c and the auxiliary projecting portion 122d have a downwardly convex arc shape. Therefore, the projecting portion 122c and the auxiliary projecting portion 122d are located along a moving locus of the concave portion 21d of the operating lever connecting portion 21c and the operation connecting portion 52a of the locking cable 52. The retaining projection 123a of the cover body 122b is constructed to be engaged with the locking cable 52 and retain the cover body 122b. The elastic retaining hook 123c of the cover body 122b is constructed to be engaged with an elastic retaining piece 123f formed on the main casing 12. The pair of elastic retaining pieces 123d of the cover body 122b are constructed to be engaged with elastic retaining hooks 123g formed on the main casing 12.

In this way, after the concave portion 21d of the locking lever 21 and the operation connecting portion 52a of the locking cable 52 are connected to each other, the opening portion 13 of the housing 10 can be closed by the cover body 122b formed integrally with the main casing 12 of the housing 10. At this time, the projecting portion 122c of the cover body 122b prevents a dropout of the operation connecting portion 52a of the locking lever 21. Therefore, if the operation connecting portion 52a of the locking cable 52 is connected to the concave portion 21d of the locking lever 21 placed in the housing 10 and the cover body 122b closes the opening portion 13, the operation connecting portion 52a of the locking cable 52 becomes difficult to drop off from the concave portion 21d of the locking lever 21. Therefore, the operation connecting portion 52a of the locking cable 52 and the concave portion 21d of the locking lever 21 can be easily connected to each other only by closing the opening portion 13 of the housing 10 by the cover body 122b. Moreover, as shown in FIG. 6, owing to the contact of the convex portion 12c with the locking lever 21, the connection between the concave portion 21d of the locking lever 21 and the operation connecting portion 52a of the locking cable 52 can be sandwiched by the convex portion 12c and the projecting portion 122c of the cover body 122b. Therefore, the dropout of the operation connecting portion 52a of the locking cable 52 from the concave portion 21d of the locking lever 21 can be more securely prevented.

In this automotive door lock device, as shown in FIG. 4, a fore end of the sub lever 21b of the locking lever 21 is engaged with a long hole 24a formed on the open link 24. A lower end of the open link 24 is engaged with one end of the open lever 28. As shown in FIG. 4, the open lever 28 is swingably provided within the second casing portion 12b of the main casing 12, and the other end of the open lever 28 is engaged with an outside cable not shown, and the outside cable is connected to an outside handle (not shown) provided on the outside of a door. Moreover, the lift lever 29 is swingably provided within the second casing portion 12b of the main casing 12, and the pawl 42 is swingably engaged with the lift lever 29. Moreover, the lift lever 29 is swingably engaged by a flange portion 24b formed on the center of the open link 24.

Moreover, as shown in FIG. 4, the active lever 21a of the locking lever 21 can be engaged with the wheel gear 22, and the wheel gear 22 is connected to the motor M by way of the worm gear 23.

Furthermore, the swing center 210 of the locking lever 21 is engaged with a swing center of the second inside lever 25. The swing center of the second inside lever 25 is engaged with a swing center of the first inside lever 26. A slide bush 25a is slidably engaged with a fore end of the second inside lever 25, and the slide bush 25a is engaged with an engaging hole 26a formed at one end of the first inside lever 26. The swing center of the first inside lever 26 is engaged with a swing center of the child protector lever 27. The other end of the first inside lever 26 is engaged with an inside cable 26b connected to an inside handle (not shown).

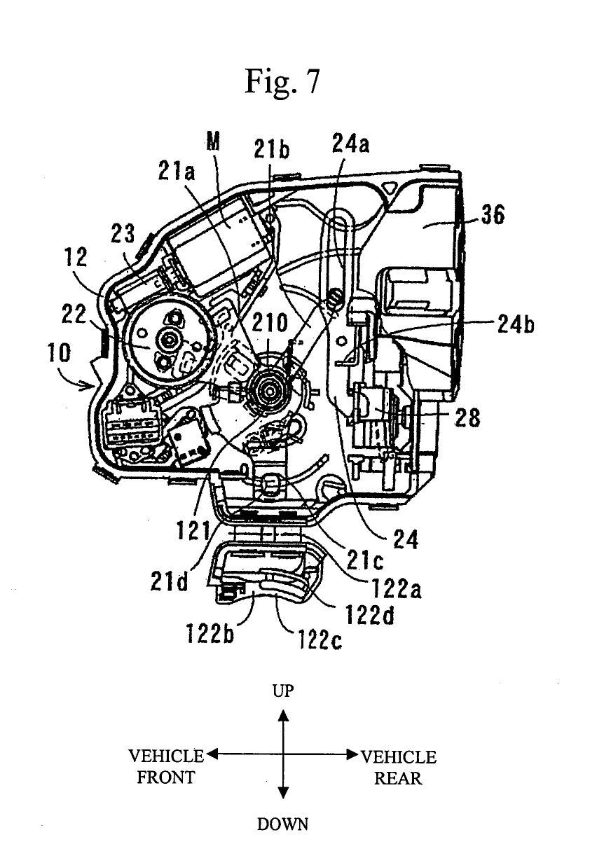

In the automotive door lock device having the above construction, upon operating the outside handle (not shown) provided outside of the door, the outside cable not shown is operated. The operation of the outside cable makes the open lever 28 engaged with the outside cable swing. Upon swinging of the open lever 28, as shown in FIG. 7, the lower end of the open link 24 is lifted and the lift lever 29 is swung by the flange portion 24b of the open link 24. The swing of the lift lever 29 makes the pawl 42 shown in FIG. 3 swing. The swing of the pawl 42 makes the ratchet 44 swing. The ratchet 44 is disengaged from a striker not shown and released from the engagement with the door having the striker. Thus, the door can be opened by operating the outside handle.

Moreover, upon operating the inside handle (not shown), the inside cable 26b is operated. The operation of the inside cable 26b makes the first inside lever 26 swing. The swing of the first inside lever 26 makes the second inside lever 25 swing by way of the slide bush 25a. The swing of the second inside lever 25 makes the flange portion 24b of the open link 24 lifted. Then, as shown in FIG. 7, the open link 24 is lifted with the flange portion 24b, and the lift lever 29 is swung by the flange portion 24b of the open link 24. The swing of the lift lever 29 makes the pawl 42 swing. Then, the swing of the pawl 42 makes the ratchet 44 swing. The ratchet 44 is disengaged from the striker (not shown) and released from the engagement with the door having the striker. Thus, the door can be opened by operating the inside handle.

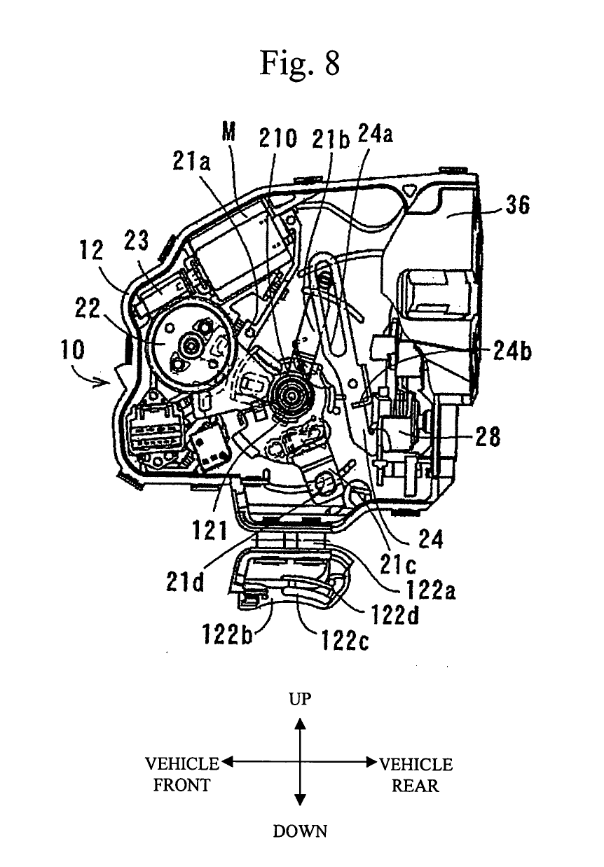

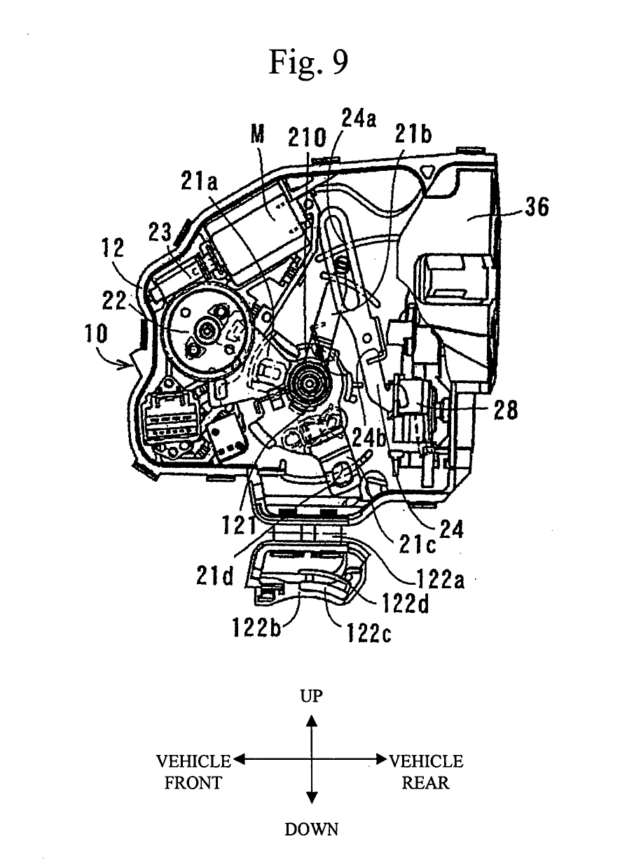

Furthermore, upon operating the locking cable 52, the concave portion 21d as well as the operation connecting portion 52a is swung. At this time, the operation connecting portion 52a and the concave portion 21d are swung in an arc-shaped moving locus along the shape of the abovementioned projecting portion 122c and auxiliary projecting portion 122d of the cover body 122b. Since the operation connecting portion 52a and the concave portion 21d are in slidable contact with each other, their connection is hardly broken even if the operation connecting portion 52a and the concave portion 21d swing in the arc-shaped moving locus. As shown in FIG. 8, the swing of the concave portion 21d makes the locking lever 21 swing in the counterclockwise direction. The swing of the locking lever 21 makes the sub lever 21b swing similarly. The swing of the sub lever 21b makes a fore end of the sub lever 21b move in the counterclockwise direction. The movement of the sub lever 21b makes the open link 24 engaged by the long hole 24a incline more as the sub lever 21 moves farther. Therefore, the flange portion 24b of the open link 24 is disengaged from the lift lever 29. Therefore, as shown in FIG. 9, even if the abovementioned outside handle or inside handle is operated, the open link 24 and the lift lever 29 do not come in engagement and accordingly the pawl 42 and the ratchet 44 shown in FIG. 3 are not swung. Thus, the door can be locked by operating the locking cable 52.

In the abovementioned embodiment, not only the locking lever 21 but also the open lever 28 and the first inside lever 26 can be used as the operating lever member. Moreover, the concave portion 21d which serves as the operating lever connecting portion can also be formed on the open lever 28 or the first inside lever 26. Furthermore, not only the locking cable 52 but also the inside cable 26b and the outside cable can be used as the operation means. Moreover, the spherical operation connecting portion 52a can also be formed on a fore end of the inside cable 26b or the outside cable.

1. An automotive door lock device, comprising: a housing having a housing body including an opening portion, and a cover portion formed integrally with the housing body for opening and closing the opening portion; an operating lever member placed in the housing and having an operating lever connecting portion; and operation means having an operation connecting portion to be connected to the operating lever connecting portion,
wherein the cover portion of the housing has an arc-shaped projecting portion for preventing a dropout of the operation connecting portion of the operation means, and the projecting portion is located along an arc-shaped moving locus of the operation connecting portion.

2. The automotive door lock device recited in claim 1, wherein the projecting portion prevents the dropout by inhibiting movement in a direction to separate from the operating lever connecting portion to which the operation connecting portion is connected.

3. The automotive door lock device recited in claim 1, wherein a convex portion capable of contacting the operating lever member is formed on the housing at a position facing the projecting portion of the cover portion in a closed state.

4. The automotive door lock device recited in claim 3, wherein the convex portion prevents the dropout by inhibiting movement in a direction to separate from the operation connecting portion to which the operating lever connecting portion is connected.

5. The automotive door lock device recited in claim 1, wherein either one of the operating lever connecting portion and the operation connecting portion is constituted by a concave portion, and the other one of the operating lever connecting portion and the operation connecting portion is a spherical portion to be attached and connected to the concave portion.

6. The automotive door lock device recited in claim 5, wherein the operating lever connecting portion is the concave portion and the operation connecting portion is the spherical portion held slidably by the concave portion.

7. The automotive door lock device recited in claim 5, wherein a tapered surface is formed on an opening periphery of the concave portion and a projection is formed inside the opening periphery.

8. The automotive door lock device recited in claim 5, wherein an opening of the concave portion faces the opening portion of the housing body.

9. The automotive door lock device recited in claim 5, wherein space sectioned by the concave portion is hemispherical.

10. The automotive door lock device recited in claim 1, wherein the housing body and the cover portion have distance keeping means for keeping the distance between the housing body and the cover portion constant when the cover portion is in a closed state.
